(19) United States
(12) Patent Application Publication
(10) Pub. No.: US 2008/0068535 A1
(43) Pub. Date: Mar. 20, 2008

(54) LIQUID CRYSTAL EO FILM INCLUDING PARTICLES HAVING LARGE SURFACE AREA AND METHOD OF FABRICATING THE SAME

(75) Inventors: Chin-Chin Tsai, Taichung County (TW); Wei-Hsin Hou, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/613,199

(22) Filed: Dec. 20, 2006

(30) Foreign Application Priority Data
Sep. 19, 2006 (TW) 95134564

(51) Int. Cl. G02F 1/1333

(52) U.S. Cl. 349/86

(57) ABSTRACT

A liquid crystal (LC) electro-optics (EO) film with particles having a large surface area is provided, which includes an EO substrate with an electrode layer, an LC mixture coating layer and a conductive polymer layer. The LC mixture coating layer is located on the surface of the EO substrate and contains sponge particles and liquid crystal. The LC mixture coating layer is covered with the conductive polymer layer that does not contact with the electrode layer.

### CROSS-REFERENCE TO RELATED APPLICATION

This application claims the priority benefit of Taiwan application serial no. 95134564, filed on Sep. 19, 2006. All disclosure of the Taiwan application is incorporated herein by reference.

### BACKGROUND OF THE INVENTION

1. Field of the Invention

The present invention relates to a liquid crystal (LC) electro-optics (EO) film and a method of fabricating the same, and more particularly to a liquid crystal EO film including particles having a large surface area (also called sponge particles) and a method of fabricating the same.

2. Description of Related Art

The LC EO film is one of the most prevailing technologies on display devices, thus, the technical innovations for increasing the throughput, reducing the cost and improving the panel performance have been carried out among all walks of life.

FIG. 1A is a schematic cross-sectional view of a conventional glass liquid crystal display (LCD). Referring to FIG. 1A, the conventional glass LCD 100 is formed by two EO glass substrates 102, 104, liquid crystal 106 and spacer balls 108. The EO glass substrates 102, 104 are laminated with each other, and the liquid crystal 106 is sandwiched there-between. The gap between the EO glass substrates 102, 104 is properly controlled by the spacer balls 108. Moreover, the edges of the EO glass substrates 102, 104 are usually sealed with edge sealants 110. Conventionally, as for the glass LCD 100 of FIG. 1A, generally, the edge sealants 110 are formed on the edges of the EO glass substrates 102, 104 first. Next, the spacer balls 108 are distributed onto the EO glass substrate 102. Next, the EO glass substrates 102, 104 are assembled. Next, the liquid crystal 106 is injected and sealed by means of vacuum injection. Thus, the process is complicated and time-consuming, which may take over 24 hours to finish the filling and sealing process, thus low production efficiency. Recently, a new process of one drop filling has been developed successfully, but it still takes several hours to complete an LC filling and sealing process, and thus low production efficiency.

Recently, a new technology has been developed, which adopts the uniform size particles with a large surface area (also called sponge particles) as the spacer particles to control the thickness of the EO material (i.e., the cell gap), and the process of fabricating the particles having a large surface area has been disclosed in U.S. Pat. No. 5,270, 445.

FIG. 1B is a schematic cross-sectional view of another conventional LCD 100a. The particles 108a having a large surface area are characterized in the accidented hill-shape or porous surface pattern, which is used to provide the interaction between molecules of the EO material, so as to create unique EO characteristics of the EO elements of a flexible liquid crystal display or an electro-optic modulator (EOM). The particles having a large surface area are manufactured through a precipitation process, and they can provide a preferable EO characteristic by mixing with the EO material acted as an electro-optic media in the EO element. For example, if the liquid crystal mixed with particles having a large surface area is supplied to a flexible liquid crystal display, the particles having a large surface area become a light scattering center, which plays a crucial role for improving the viewing angle of a displayed image.

However, the LC EO film including particles having a large surface area still cannot overcome difficulties of the manufacturing process technology, such as the problem of sealing the liquid crystal, therefore, how to accomplish this kind of new LC EO film simply and quickly has become a focus in the current research.

### SUMMARY OF THE INVENTION

The present invention is directed to an LC EO film including particles having a large surface area (also called sponge particles) having an optimal optical characteristics, and a structure with a single sided substrate.

The present invention is also directed to a simple and cost effective method of fabricating an LC EO film.

The present invention is also directed to a method of fabricating an LC EO film for fabricating an LC EO film with a single sided substrate.

The present invention is further directed to an LC EO film, wherein the thickness variation or the delamination phenomenon when the LC EO film is used can be effectively avoided.

The present invention is further directed to a simple and cost effective method of fabricating an LC EO film so that fabrication throughput is increased.

The present invention is still directed to a method of fabricating an LC EO film for fabricating an LC EO film with a double sided substrate.

The present invention provides an LC EO film comprising an EO substrate with an electrode layer, an LC mixture coating layer and a conductive polymer layer. The LC mixture coating layer is located on the surface of the EO substrate and contains particles having a large surface area and liquid crystal. The LC mixture coating layer is covered with the conductive polymer layer that does not contact with the electrode layer.

The present invention further provides a method of fabricating an LC EO film, wherein an EO substrate with an electrode layer is first provided, and a mixture containing particles having a large surface area and liquid crystal is prepared. Next, a two-layer coating die is utilized to coat the electrode layer of the EO substrate with the above mixture and a conductive polymer layer to form an LC mixture coating layer. The LC mixture coating layer is covered with the conductive polymer layer not in contact with the electrode layer.

The present invention further provides a method of fabricating an LC EO film, wherein an EO substrate with an electrode layer is first provided, and a mixture containing particles having a large surface area and liquid crystal is prepared. Next, the electrode layer of the EO substrate is coated with the above mixture to form an LC mixture coating layer. Next, the LC mixture coating layer is coated with a conductive polymer layer, thus, the LC mixture coating layer is covered with the conductive polymer layer not in contact with the electrode layer.

The present invention further provides an LC EO film, which comprises a first EO substrate, a second EO substrate, an LC mixture coating layer and a photosensitive curing coating layer. The LC mixture coating layer is located on the surface of the first EO substrate and contains particles having a large surface area and liquid crystal. The LC mixture coating layer is covered with the photosensitive curing coating layer, and the second EO substrate is laminated on one surface of the first EO substrate having the LC mixture coating layer.

The present invention further provides a method of fabricating an LC EO film, which comprises the following steps. First, a mixture containing particles having a large surface area and liquid crystal is prepared. Next, a two-layer coating die is used to coat a continuous first EO substrate with the mixture and a photosensitive curing coating layer, thus making the above mixture to become an LC mixture coating layer, and the LC mixture coating layer is covered with the photosensitive curing coating layer. Next, a continuous second EO substrate is laminated on one surface of the first EO substrate having the LC mixture coating layer and the photosensitive curing coating layer. Next, the above photosensitive curing coating layer is cured, so as to complete the LC EO film wound roll.

The present invention further provides a method of fabricating an LC EO film, which comprises the following steps. First, a mixture containing particles having a large surface area and liquid crystal is prepared. Next, a first EO substrate is coated with the above mixture to form an LC mixture coating layer. Next, a photosensitive curing coating layer is coated on the LC mixture coating layer of the first EO substrate, such that the LC mixture coating layer is covered with the photosensitive curing coating layer. Next, a second EO substrate is laminated on one surface of the first EO substrate having the LC mixture coating layer and the photosensitive curing coating layer, and the photosensitive curing coating layer is cured.

The present invention adopts a roll-to-roll process to fabricate an LC EO film, thus an LC EO film with optimal optical characteristics is obtained. Furthermore, the LC mixture coating layer with particles having a large surface area is completely covered with the photosensitive curing coating layer in the present invention, so as to avoid the thickness variation or delamination phenomenon while being used.

In order to make the aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a conventional LC EO film.

FIG. 1B is a schematic cross-sectional view of another conventional LC EO film.

FIGS. 2A and 2B are respectively schematic cross-sectional views of two kinds of LC EO films including particles having a large surface area according to a first embodiment of the present invention.

FIG. 3 is a schematic flow chart of fabricating an LC EO film including particles having a large surface area according to a second embodiment of the present invention.

FIG. 4 is an enlarged schematic flow chart of Part IV of the second embodiment.

FIG. 5 is a schematic flow chart of fabricating a flexible LC EO film including particles having a large surface area according to a third embodiment of the present invention.

FIG. 6 is a schematic cross-sectional view of an LC EO film including particles having a large surface area according to a forth embodiment of the present invention.

FIG. 7 is a schematic flow chart of fabricating an LC EO film including particles having a large surface area according to a fifth embodiment of the present invention.

FIG. 8 is an enlarged schematic flow chart of Part VIII of the fifth embodiment.

FIG. 9 is a flow chart of fabricating a flexible LC EO film including particles having a large surface area according to a sixth embodiment of the present invention.

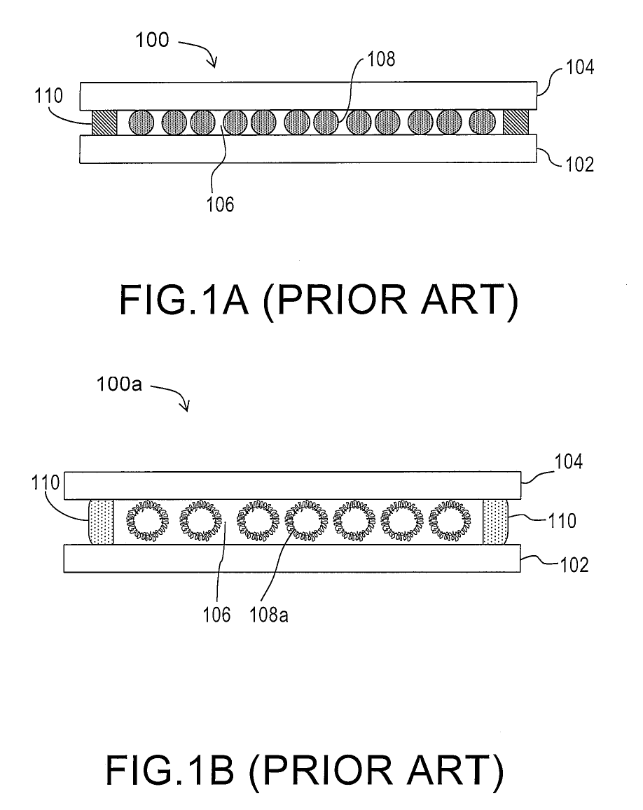

### DESCRIPTION OF EMBODIMENTS

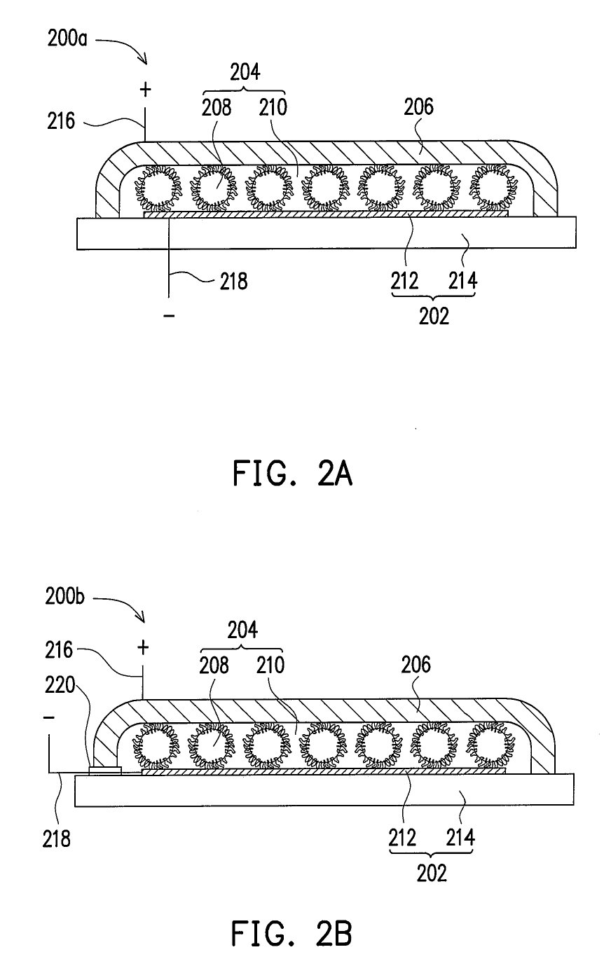

FIGS. 2A and 2B are respectively schematic cross-sectional views of two kinds of LC EO films including particles having a large surface area (briefly called sponge particles) according to a first embodiment of the present invention.

Referring to FIGS. 2A and 2B, the LC EO films 200a and 200b both include an EO substrate 202, an LC mixture coating layer 204 and a conductive polymer layer 206. The LC mixture coating layer 204 contains particles 208 having a large surface area and liquid crystal 210, and the EO substrate 202 has an electrode layer 212. The LC mixture coating layer 204 is located on the surface of the EO substrate 202, and the LC mixture coating layer 204 is covered with the conductive polymer layer 206 not in contact with the electrode layer 212, wherein the conductive polymer layer 206 is, for example, a transparent conductive polymer layer, and the width of the conductive polymer layer 206 is at least over 0.5 mm larger than that of the LC mixture coating layer 204. In the first embodiment, the particles 208 having a large surface area have accidented hill-shaped protruding structures, gauffers or cilia densely distributed on the surface, such that the particles have a large irregular surface. Moreover, the diameter of the particles 208 having a large surface area is, for example, between 3 μm and 20 μm. The EO substrate 202 includes a continuous EO substrate wound roll.

FIG. 2A still shows a first leading wire 216 connected to the conductive polymer layer 206, and a second leading wire 218 connected to the electrode layer 212 through the EO substrate 202. Furthermore, the second leading wire 218 in FIG. 2B is connected to the electrode layer 212 through an insulating structure 220 formed on the EO substrate 202.

In the first embodiment, the liquid crystal 210 includes cholesteric liquid crystal (CHLC), twisted nematic (TN) liquid crystal, or super twisted nematic (STN) liquid crystal. Furthermore, the liquid crystal 210 includes a guest-host liquid crystal added with dichroic dyes.

In the first embodiment, the EO substrate 202 includes a flexible substrate 214, which is made of polyethylene terephthalate (PET), polyethylene naphthalate (PEN), polyethersulfone (PES), polycarbonate (PC), polyimide (PI), cyclo olefin copolymer (COC), cyclo olefin polymer (COP), or epoxy. Moreover, the flexible substrate 214 further includes glass, plastic, leather, cloth or paper, etc. The material of the electrode layer 212 includes: metal, such as Al, Cu, Mo, Ag, Au; transparent conductive material, such as indium tin oxide (ITO), antimony tin oxide (ATO); or polymeric conductive material, such as poly(3,4-ethylenedioxy-thiophene) (PEDOT). Moreover, the electrode layer 212 is a plain electrode layer or a patterned electrode layer. Since the LC mixture coating layer 204 is covered with the conductive polymer layer 206 in the LC EO film 200 of the first embodiment, an LC EO film with a single sided substrate can be fabricated, thus greatly increasing the application range.

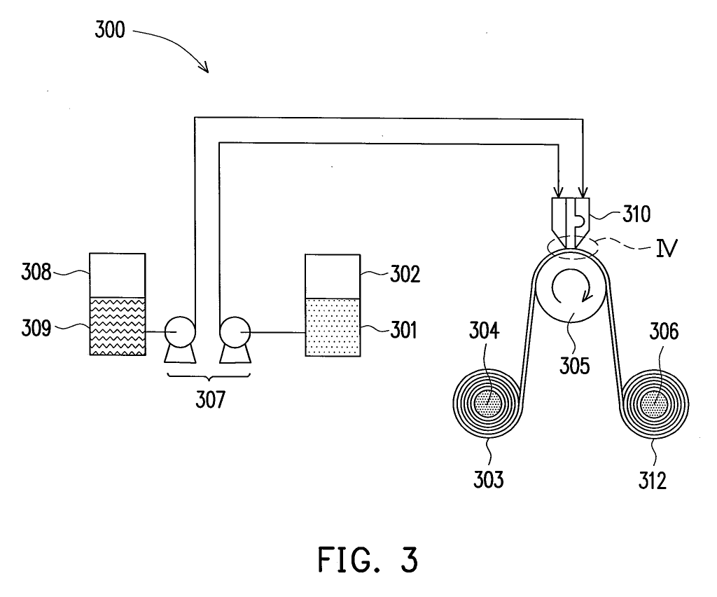

FIG. 3 is a schematic flow chart of fabricating an LC EO film including particles having a large surface area according to a second embodiment of the present invention.

Referring to FIG. 3, the fabricating method in the second embodiment adopts a roll-to-roll process device 300, which includes the steps of preparing a mixture 301 containing particles having a large surface area and liquid crystal, and then, placing the mixture 301 in a supply tank 302 as shown in the figure. Moreover, the method of preparing the mixture 301 includes, for example, quantifying the particles having a large surface area and the liquid crystal respectively, and placing the liquid crystal into a shaking stirred tank. Next, the above mixture is agitated/stirred while adding the particles having a large surface area slowly. Next, de-aeration process is carried out after blending process. Meanwhile, each substrate and each part are all installed through the roll-to-roll process device 300. For example, a continuous first EO substrate 303 is placed on an unwinding roll 304, outspreaded along the coating line, and fixed on a rewinding roll 306 after passing though a coating roll 305.

Next, still referring to FIG. 3, the mixture 301 and the conductive polymer 309 contained in another supply tank 308 as shown in the figure are injected into a two-layer coating die 310 by the metering pumps 307, and then, the continuous EO substrate 303 is coated with both the mixture 301 and the conductive polymer 309 at the same time, thus transforming above mixture 301 into an LC mixture coating layer on the EO substrate 303, and the LC mixture coating layer is covered with the conductive polymer 309, so as to form a conductive polymer layer. Next, the rewinding roll 306 is used to rewind. Thus, the fabrication of the LC EO film wound roll 312 is completed.

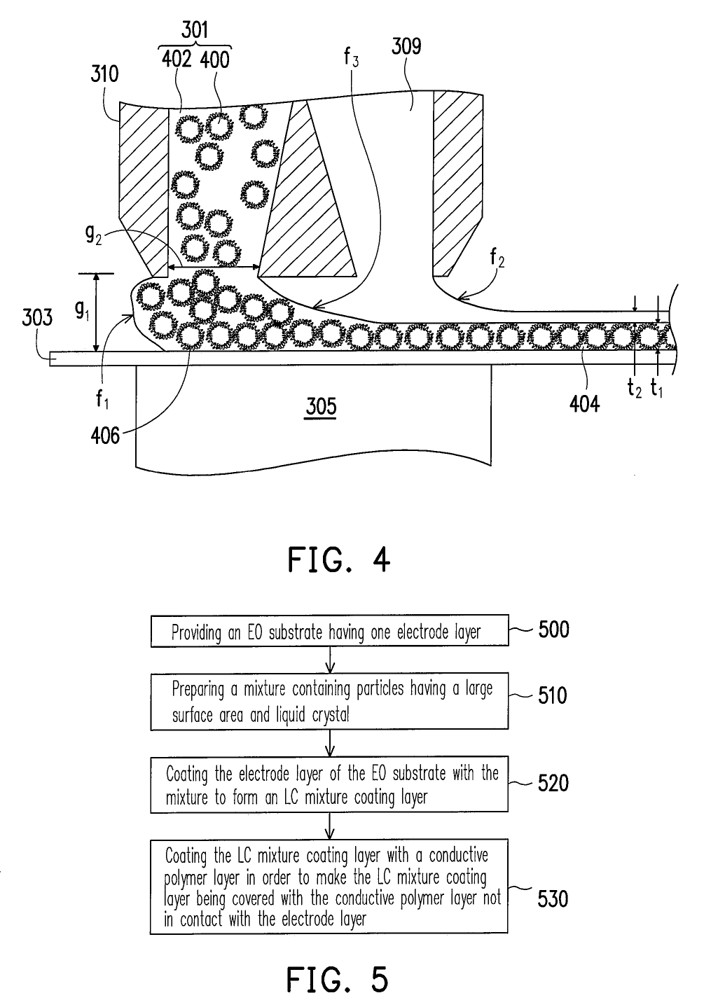

FIG. 4 is an enlarged schematic flow chart of Part IV of the second embodiment.

Referring to FIG. 4, Part IV shows distribution changes of the particles 400 having a large surface area when the mixture 301 and the conductive polymer 309 are applied by the two-layer coating die 310. The two-layer coating technology can be obtained by the process disclosed in “Liquid Film Coating: Scientific Principles and Their Technological Implications” (Stephan F. Kistler and Peter M. Schweizer, eds, ISBN: 0412064812, Chapman & Hall) published in 1997. For example, the coating thickness of the LC mixture coating layer 404, containing particles 400 having a large surface area and liquid crystal 402, coated on the first EO substrate 303 is set as t1 (μm), which is approximately equivalent to the diameter of the particles 400 having a large surface area, the setting method is t₁ (μm)=10000×coating weight (cc/min)÷[width (cm)×coating speed (cm/mm)]. The coating thickness of the conductive polymer 309 is set as t₂ (μm) through the same method. Moreover, since the conductive polymer 309 has a relatively larger width, it covers the two sides of the LC mixture coating layer 404, thus directly sealing the LC mixture coating layer 404. Then, the gap between the two-layer coating die 310 and the coating roll 305 must be adjusted to an appropriate coating gap g₁ (μm), which is usually set to be 5-20 times larger than the coating thickness t₁ of the bottom layer (the LC mixture coating layer 404). The two-layer coating die 310 has different widths, wherein the width of the conductive polymer 309 is about several millimeters larger than that of the LC mixture coating layer 404, and preferably at least over 0.5 mm larger than that of the LC mixture coating layer 404.

Next, still referring to FIG. 4, the coating weights of the metering pumps 307 (see FIG. 3) are set respectively and they are initiated, so that the mixture 301 and the conductive polymer 309 are injected into the two-layer coating die 310 from the tanks 302 and 308 respectively (see FIG. 3). The coating roll 305 is initiated after the two-layer coating die 310 is fully filled with the mixture 301 and the conductive polymer 309. Meanwhile, the mixture 301 and the conductive polymer 309 form a coating bead 406 in the coating gap g₂. In order to adjust the coating quality to an optimal state, the behavior between the coating bead 406 and a wetting meniscus f₁, a film forming meniscus f₂, and an interfacial meniscus f₃ must be controlled.

Next, referring to FIG. 4, the bottom layer of the coating bead 406 is fully filled with particles 400 having a large surface area and liquid crystal 402. When an appropriate shear force is controlled, a shear alignment phenomenon occurs for the coating bead 406 when the LC mixture coating layer 404 is formed, thus making the particles 400 having a large surface area be configured into a single-layer structure, i.e., there is only one layer of particles having a large surface area in the direction of the coating thickness t₁. The diameters of the particles 400 having a large surface area are uniform, which can be used to control the LC gap of the LC EO film 312.

FIG. 5 is a schematic flow chart of fabricating a flexible LC EO film including particles having a large surface area according to a third embodiment of the present invention.

Referring to FIG. 5, in Step 500, an EO substrate having one electrode layer is provided. Next, in Step 510, a mixture containing particles having a large surface area and liquid crystal is prepared. Next, in Step 520, the electrode layer of the EO substrate is coated with the mixture to form an LC mixture coating layer. After forming the LC mixture coating layer, the step of solidifying the LC mixture coating layer is selectively carried out.

Finally, in Step 530, the LC mixture coating layer is coated with a conductive polymer layer, thus, the LC mixture coating layer is covered with the conductive polymer layer not in contact with the electrode layer. Next, a first leading wire is further connected to the conductive polymer layer, and a second leading wire is connected to the electrode layer through the EO substrate. Furthermore, an insulating structure can be first formed on the EO substrate, and then, the second leading wire is connected to the electrode layer through the above insulating structure.

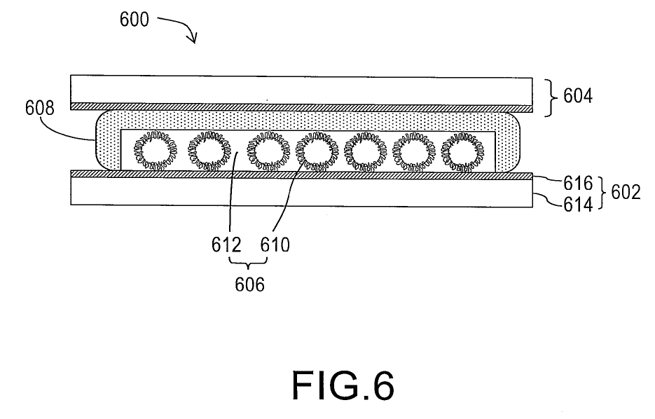

FIG. 6 is a schematic cross-sectional view of an LC EO film including particles having a large surface area according to a forth embodiment of the present invention.

Referring to FIG. 6, the LC EO film 600 in the forth embodiment includes a first EO substrate 602, a second EO substrate 604, an LC mixture coating layer 606 and a photosensitive curing coating layer 608. The LC mixture coating layer 606 contains particles 610 having a large surface area and liquid crystal 612. The LC mixture coating layer 606 is located on the surface of the first EO substrate 602, and covered with the photosensitive curing coating layer 608, wherein the photosensitive curing coating layer 608 is, for example, an curing coating layer and has a width being at least over 0.5 mm larger than that of the LC mixture coating layer 606. The second EO substrate 604 is laminated on the surface of the first EO substrate 602 having the LC mixture coating layer 606 and the photosensitive curing coating layer 608. The materials and sizes of the particles 610 having a large surface area, EO substrates 602, 604, and the flexible substrate 614 and the electrode layer 616 in the EO substrates 602, 604 have a similar or the same range as those described in the first embodiment. The LC EO film 600 in the forth embodiment has the LC mixture coating layer 606 covered with the photosensitive curing coating layer 608, thereby preventing the delamination phenomenon or the thickness variation from occurring to the LC mixture coating layer 606.

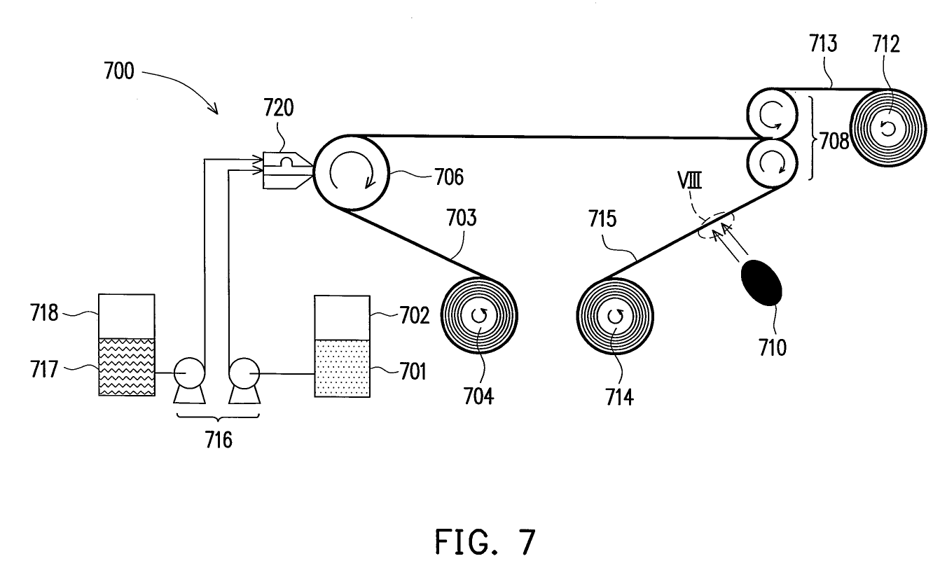

FIG. 7 is a schematic flow chart of fabricating an LC EO film comprising particles having a large surface area according to a fifth embodiment of the present invention.

Referring to FIG. 7, the fabricating method of the fifth embodiment adopts a roll-to-roll process device 700, which includes steps of preparing a mixture 701 containing particles having a large surface area and liquid crystal, and then, placing the mixture in a supply tank 702 as shown in the figure. Moreover, the method of preparing the above mixture 701 includes, for example, quantifying the particles having a large surface area and the liquid crystal respectively, and placing the liquid crystal into an agitated stirred tank; next, agitated and stirring it while adding the particles having a large surface area slowly. Next, for the agitation and the stirring is stopped and the de-aeration is performed after the blending process. Meanwhile, each substrate and each part can be installed through the roll-to-roll process device 700. For example, a continuous first EO substrate 703 is placed on an unwinding roll 704, outspreaded along the coating line, and fixed on a rewinding roll 714 after passing through a coating roll 706, a laminator 708, an exposure unit 710 after being laminated with the second EO substrate 713 from the unwinding roll 712 for laminating, and the tension of the two EO substrates 703, 713 and that of the LC EO film 715 are adjusted.

Next, still referring to FIG. 7, the mixture 701 and a photosensitive curing coating solution, paste or gel 717 contained in another supply tank 718 as shown in the figure are injected into a two-layer coating die 720 by the metering pumps 716, and the continuous first EO substrate 703 is coated with the mixture 701 and the photosensitive curing coating solution, paste or gel 717 at the same time, thus transforming the mixture 701 into an LC mixture coating layer on the first EO substrate 703, and the LC mixture coating layer is covered with the photosensitive curing coating solution, paste or gel 717, wherein the photosensitive curing coating solution, paste or gel 717 includes the photosensitive curing solution, paste or gel as an example in the second embodiment. The detailed operations will be described below.

Next, referring to FIG. 7 again, when the first EO substrate 703 enters the laminator 708, the continuous second EO substrate 713 is laminated on the surface of the first EO substrate 703 by controlling an appropriate laminating pressure, a laminating temperature and a laminating gap. Next, the above photosensitive curing coating solution, paste or gel 717 is cured, and the curing method in the present embodiment utilize the irradiation exposure unit 710 to cure the photosensitive curing coating solution, paste or gel 717, and the rewinding roll 714 is used to rewind, so as to complete LC EO film 715 wound roll.

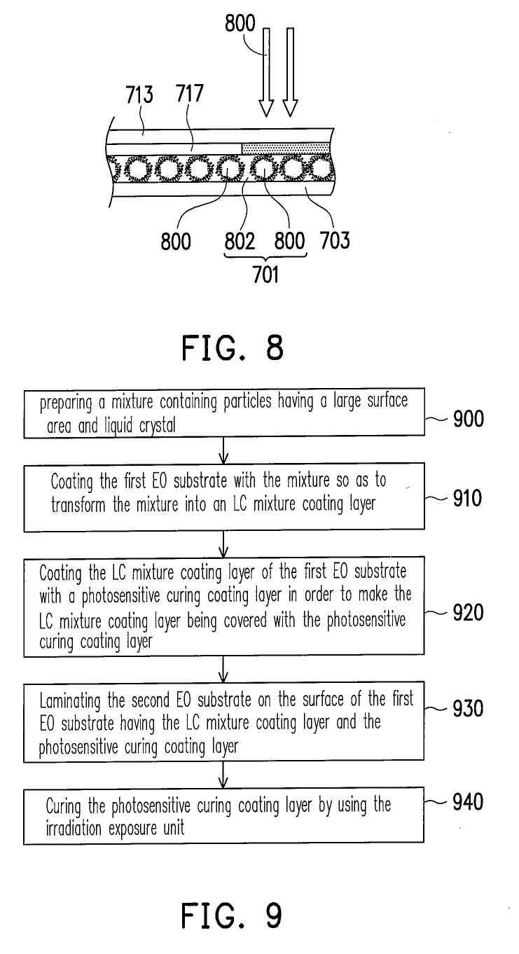

FIG. 8 is an enlarged schematic flow chart of Part VIII of the fifth embodiment. Referring to FIG. 8, Part VIII is an enlarged view of FIG. 7 when the photosensitive coating solution, paste or gel 717 is cured. As shown in the figure, the photosensitive curing coating solution, paste or gel 717 is exposed by an irradiation light 800 with an appropriate wavelength, an exposure energy, and an exposure intensity through the second EO substrate 713.

FIG. 9 is a flow chart of fabricating a flexible LC EO film comprising particles having a large surface area according to a sixth embodiment of the present invention.

Referring to FIG. 9, in Step 900, a mixture containing particles having a large surface area and liquid crystal is prepared. Next, in Step 910, the first EO substrate is coated with the mixture, thus transforming the mixture into an LC mixture coating layer. Moreover, the step of solidifying the LC mixture coating layer is selectively carried out after forming the LC mixture coating layer.

Next, in Step 920, the LC mixture coating layer of the first EO substrate is coated with a photosensitive curing coating layer, thus, the LC mixture coating layer is covered with the photosensitive curing coating layer. The width of the photosensitive curing coating layer is selectively at least over 0.5 mm larger than that of the LC mixture coating layer. The above photosensitive curing coating layer is preferably a photosensitive curing coating solution, paste or gel.

Next, in Step 930, the second EO substrate is laminated on the surface of the first EO substrate having the LC mixture coating layer and the photosensitive curing coating layer. Finally, in Step 940 the photosensitive curing coating layer is cured by using the irradiation exposure unit. The irradiation exposure unit includes electron beam exposure unit or ultraviolet light exposure unit, for example.

In view of the above, the present invention applies the particles having a large surface area for improving the optical characteristic in both the single sided and double sided EO substrates, thus greatly enlarging the application range. Moreover, the present invention adopts the roll-to-roll process with a two-layer coating die to fabricate the LC EO film, thus greatly reducing the process time, and the LC EO film of the present invention contains the particles having a large surface area, thus improving the optical characteristic. Furthermore, the LC EO film in the present invention has the LC mixture coating layer being completely covered with the photosensitive curing coating layer, thus, the thickness variation and the delamination phenomenon can be avoided when the LC EO film is used.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

What is claimed is:

1. A liquid crystal (LC) electro-optics (EO) film, comprising:
an EO substrate, having an electrode layer;
an LC mixture coating layer, located on one surface of the EO substrate, containing particles having a large surface area and liquid crystal; and
a conductive polymer layer, covering the surface of the LC mixture coating layer not in contact with the electrode layer.

2. The LC EO film as claimed in claim 1, wherein the particles having a large surface area have densely distributed accidented hill-shaped protruding structures.

3. The LC EO film as claimed in claim 1, wherein a diameter of the particles having a large surface area is between 3 μm and 20 μm.

4. The LC EO film as claimed in claim 1, wherein the EO substrate comprises a continuous EO substrate.

5. The LC EO film as claimed in claim 1, wherein the width of the conductive polymer layer is at least over 0.5 mm larger than that of the LC mixture coating layer.

6. The LC EO film as claimed in claim 1, further comprising:
a first leading wire, connected to the conductive polymer layer; and
a second leading wire, connected to the electrode layer through the EO substrate.

7. The LC EO film as claimed in claim 1, further comprising:
a first leading wire, connected to the conductive polymer layer;
an insulating structure, formed on the EO substrate; and
a second leading wire, connected to the electrode layer through the insulating structure.

8. The LC EO film as claimed in claim 1, wherein the conductive polymer layer comprises a transparent conductive polymer layer.

9. The LC EO film as claimed in claim 1, wherein a material of the electrode layer comprises metal, transparent conductive material or polymer conductive material.

10. The LC EO film as claimed in claim 1, wherein the EO substrate comprises a flexible substrate.

11. The LC EO film as claimed in claim 10, wherein the flexible substrate comprises glass, plastic, leather, cloth or paper.

12. A method of fabricating an LC EO film, comprising:
providing an EO substrate with an electrode layer;
preparing a mixture containing particles having a large surface area and liquid crystal; and
using a two-layer coating die to coat the electrode layer of the EO substrate with the mixture and a conductive polymer layer to transform the mixture into an LC mixture coating layer, wherein the LC mixture coating layer is covered with the conductive polymer layer not in contact with the electrode layer.

13. The method of fabricating the LC EO film as claimed in claim 12, after forming the LC mixture coating layer, further comprising:
connecting a first leading wire to the conductive polymer layer; and
connecting a second leading wire to the electrode layer through the EO substrate.

14. The method of fabricating the LC EO film as claimed in claim 12, wherein after the step of forming the LC mixture coating layer, further comprising:
connecting a first leading wire to the conductive polymer layer;
forming an insulating structure on the EO substrate; and
connecting a second leading wire to the electrode layer through the insulating structure.

15. The method of fabricating the LC EO film as claimed in claim 12, wherein a width of the conductive polymer layer is at least over 0.5 mm larger than that of the LC mixture coating layer.

16. A method of fabricating an LC EO film, comprising:
providing an EO substrate with an electrode layer;
preparing a mixture containing particles having a large surface area and liquid crystal;
coating the electrode layer of the EO substrate with the mixture to transform the mixture into an LC mixture coating layer; and
coating the LC mixture coating layer with a conductive polymer layer, such that the LC mixture coating layer is covered with the conductive polymer layer not in contact with the electrode layer.

17. The method of fabricating the LC EO film as claimed in claim 16, further comprising a step of solidifying the LC mixture coating layer after the step of forming the LC mixture coating layer but before the step of applying the conductive polymer layer.

18. The method of fabricating the LC EO film as claimed in claim 16, wherein after the step of applying the conductive polymer layer, further comprising:
connecting a first leading wire to the conductive polymer layer; and
connecting a second leading wire to the electrode layer through the EO substrate

19. The method of fabricating the LC EO film as claimed in claim 16, wherein after the step of applying the conductive polymer layer, further comprising:
connecting a first leading wire to the conductive polymer layer;
forming an insulating structure on the EO substrate; and
connecting a second leading wire to the electrode layer through the insulating structure.

20. The method of fabricating the LC EO film as claimed in claim 16, wherein the width of the conductive polymer layer is at least over 0.5 mm larger than that of the LC mixture coating layer.

21. An LC EO film, comprising:
a first EO substrate;
an LC mixture coating layer, located on a surface of the first EO substrate, containing particles having a large surface area and liquid crystal;
a photosensitive curing coating layer, covering the surface of the LC mixture coating layer; and
a second EO substrate, laminated on the surface of the first EO substrate.

22. The LC EO film as claimed in claim 21, wherein the particles having a large surface area have densely distributed accidented hill-shaped protruding structures.

23. The LC EO film as claimed in claim 21, wherein a diameter of the particles having a large surface area is between 3 μm and 20 μm.

24. The LC EO film as claimed in claim 21, wherein the first EO substrate and the second EO substrate comprise a continuous EO substrate.

25. The LC EO film as claimed in claim 21, wherein the photosensitive curing coating layer comprises an photosensitive curing solution, paste or gel.

26. The LC EO film as claimed in claim 21, wherein a width of the photosensitive curing coating layer is at least over 0.5 mm larger than that of the LC mixture coating layer.

27. The LC EO film as claimed in claim 21, wherein the first EO substrate comprises:
a flexible substrate; and
an electrode layer, located on the flexible substrate.

28. The LC EO film as claimed in claim 27, wherein the material of the electrode layer comprises metal, transparent conductive material or polymer conductive material.

29. The LC EO film as claimed in claim 27, wherein the electrode layer comprises a plain electrode layer or a patterned electrode layer.

30. The LC EO film as claimed in claim 27, wherein the second EO substrate comprises a flexible substrate and an electrode layer, just as the first EO substrate.

31. The LC EO film as claimed in claim 27, wherein the flexible substrate comprises glass, plastic, leather, cloth or paper.

32. A method of fabricating an LC EO film, comprising:
preparing a mixture containing particles having a large surface area and liquid crystal;
using a two-layer coating die to coat a continuous first EO substrate with the mixture and a photosensitive curing coating layer to transform the mixture into an LC mixture coating layer, wherein the LC mixture coating layer is covered with the photosensitive curing coating layer;
laminating a continuous second EO substrate on a surface of the first EO substrate having the LC mixture coating layer and the photosensitive curing coating layer; and
curing the photosensitive curing coating layer.

33. The method of fabricating the LC EO film as claimed in claim 32, wherein the photosensitive curing coating layer comprises a photosensitive curing coating solution, paste or gel.

34. The method of fabricating the LC EO film as claimed in claim 33, wherein the step of curing the photosensitive curing coating layer is carried out using an irradiation exposure unit.

35. The method of fabricating the LC EO film as claimed in claim 34, wherein the irradiation exposure unit comprises electron beam exposure unit or ultraviolet light exposure unit.

36. The method of fabricating the LC EO film as claimed in claim 32, wherein the width of the photosensitive curing coating layer is at least over 0.5 mm larger than that of the LC mixture coating layer.

37. A method of fabricating an LC EO film, comprising:
preparing a mixture containing particles having a large surface area and liquid crystal;
coating a first EO substrate with the mixture to transform the mixture into an LC mixture coating layer;
coating the LC mixture coating layer of the first EO substrate with a photosensitive curing coating layer, such that the LC mixture coating layer is covered with the photosensitive curing coating layer;
laminating a second EO substrate on the surface of the first EO substrate having the LC mixture coating layer and the photosensitive curing coating layer; and
curing the photosensitive curing coating layer.

38. The method of fabricating the LC EO film as claimed in claim 37, wherein the photosensitive curing coating layer comprises a photosensitive curing coating solution, paste or gel.

39. The method of fabricating the LC EO film as claimed in claim 38, wherein the step of curing the photosensitive curing coating layer is carried out using an irradiation exposure unit.

40. The method of fabricating the LC EO film as claimed in claim 39, wherein the irradiation exposure unit comprises electron beam exposure unit or ultraviolet light exposure unit.

41. The method of fabricating the LC EO film as claimed in claim 37, further comprising a step of solidifying the LC mixture coating layer after the step of forming the LC mixture coating layer but before the step of applying the photosensitive curing coating layer.

42. The method of fabricating the LC EO film as claimed in claim 37, wherein a width of the photosensitive curing coating layer is at least over 0.5 mm larger than that of the LC mixture coating layer.
